(19) United States
(12) Patent Application Publication
(10) Pub. No.: US 2016/0209278 A1
(43) Pub. Date: Jul. 21, 2016

(54) TRIBOELECTRIC PRESSURE SENSING CABLE AND PREPARATION METHOD THEREOF

(71) Applicant: NAZHIYUAN TECHNOLOGY (TANGSHAN), LLC, Hebei (CN)

(72) Inventors: CHARLES HUS, HEBEI (CN); HAO ZHAO, HEBEI (CN); LIXING HAO, HEBEI (CN); ZHU WANG, HEBEI (CN); JIAXING LANG, HEBEI (CN); LIJIA SUN, HEBEI (CN)

(73) Assignee: NAZHIYUAN TECHNOLOGY (TANGSHAN), LLC, HEBEI (CN)

(21) Appl. No.: 15/025,322

(22) PCT Filed: Jun. 16, 2014
(86) PCT No.: PCT/CN2014/079929

§ 371 Date: Mar. 28, 2016

(30) Foreign Application Priority Data
Sep. 26, 2013 (CN) 201310444935.4
Sep. 27, 2013 (CN) 201310452020.8

(51) Int. Cl. G01L 1/00; B05D 1/26; H01B 7/02; H01B 13/08; H01B 7/00; H01B 3/30

(52) U.S. Cl. CPC G01L 1/005; H01B 7/0009; H01B 3/30; H01B 7/02; H01B 13/08; B05D 1/26

(57) ABSTRACT

Provided is a triboelectric pressure sensing cable. The triboelectric pressure sensing cable comprises a central conducting wire, a high-molecular polymer insulating layer, an electrode layer, and an insulating outer layer, which are coaxially attached in sequence. The central conducting wire and the high-molecular polymer insulating layer, and/or the high-molecular polymer insulating layer and the electrode layer separately generate signals by the means of triboelectric effect. Also provided is a method for preparing the triboelectric pressure sensing cable. The method comprises the steps of (1) preparing a high-molecular polymer solution; (2) forming a hollow cavity framework used for casting; (3) casting; (4) molding; and (5) forming an insulating outer layer so as to obtain the triboelectric pressure sensing cable. The provided triboelectric pressure sensing cable can achieve a monitoring effect which is the same as that of a conventional pressure cable, without requiring a high input impedance circuit or a charge-amplifier.

### FIELD OF THE INVENTION

The present invention relates to a pressure cable, and particularly to the technical field of the preparation of a triboelectric pressure sensing cable.

### BACKGROUND

With the development of science and technology, the pressure cable has been greatly developed in the past few decades and widely used in various industrial control environment, such as water conservancy and hydropower, railway traffic, intelligent buildings, production control, aerospace, military, petrochemical, oil well, electric power, ships, machine tools, pipelines, medical and many other industries.

The output of an ordinary pressure cable is an analog signal, which refers to continuous signals presented by information parameters within a given range, or signals of any values presented at any moment in a continuous interval by the characteristic quantity of the information represented by the parameters. However, the commonly used pressure cable is made by using the piezoelectric effect. Despite such a wide application range of the pressure cable, it has disadvantages of high impedance and weak signals, so a high input impedance circuit or charge amplifier is required to overcome these disadvantages.

Especially in the field of intelligent transportation, the pressure cable has become an ideal choice in the expanding application with its characteristics of good performance, high reliability, simple installation method and gradually reducing price.

Therefore, the development of a new pressure sensing cable with higher output signal strength becomes an urgent technical problem for industry insiders.

### SUMMARY OF THE INVENTION

The technical problem solved by the present invention is to provide a triboelectric pressure sensing cable with high output signal strength.

Another technical problem solved by the present invention is to provide a method for preparing a triboelectric pressure sensing cable.

Specifically, the above technical problems are solved by the following technical solutions.

A triboelectric pressure sensing cable, comprising a central conducting wire, a high-molecular polymer insulating layer, an electrode layer and an insulating outer layer, which are coaxially attached in sequence; the central conducting wire and the high-molecular polymer insulating layer, and/or the high-molecular polymer insulating layer and the electrode layer separately generate signals by the means of triboelectric effect; and the central conducting wire and the electrode layer are output electrodes of the triboelectric pressure sensing cable.

The material used for the electrode layer is one or more selected from indium tin oxide, silver nanowire membrane, copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, and tantalum alloy.

The material used for the central conducting wire is one or more selected from copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, tantalum alloy, indium tin oxide, and silver nanowire membrane.

A triboelectric pressure sensing cable, comprising a central conducting wire, a modified high-molecular polymer insulating layer, an electrode layer, and an insulating outer layer, which are coaxially attached in sequence; the central conducting wire and the modified high-molecular polymer insulating layer, and/or the modified high-molecular polymer insulating layer and the electrode layer generate separately signals by the means of triboelectric effect; the central conducting wire and the electrode layer are output electrodes of the triboelectric pressure sensing cable, and the modified high-molecular polymer insulating layer contains a high-molecular polymer and a modified material.

The modified material is one or more selected from barium titanate, magnesium titanate, calcium titanate, nano silica, phlogopite, and muscovite.

The weight of the modified material is 1% to 45% of that of the modified high-molecular polymer.

The central conducting wire is knitted from one or more selected from tin-plated copper conducting wire, zinc-plated copper conducting wire, or silver-plated copper conducting wire.

The high-molecular polymer insulating layer or the modified high-molecular polymer insulating layer is molded on the central conducting wire through liquid solidification.

The central conducting wire and the high-molecular polymer insulating layer or the modified high-molecular polymer insulating layer are integrated, and there is little or no gap between the high-molecular polymer insulating layer and the electrode layer, or between the modified high-molecular polymer insulating layer and the electrode layer.

The electrode layer is in the form of a strip, a band, or a wire-knitted net.

There is a shielding layer arranged between the electrode layer and the insulating outer layer.

Further, there is a second high-molecular polymer insulating layer arranged between the high-molecular polymer insulating layer and the electrode layer, or between the modified high-molecular polymer insulating layer and the electrode layer.

The material used for the second high-molecular polymer insulating layer is any one of polyvinyl plastics, polypropylene plastics, fluorine plastics, polyvinyl fluoride, fluorinated ethylene propylene, nylon, polyolefin, chlorinated polyethylene, chlorosulfonated polyethylene, silicone rubber, tetrafluoroethylene-ethylene copolymer, polytrifluorochloroethylene, polystyrene, chlorinated polyether, polyimide, polyester, ethylene-vinyl acetate copolymer, thermoplastic vulcanized rubber, thermoplastic polyurethane elastomer rubber, ethylene propylene diene monomer or thermoplastic rubber, polyethylene terephthalate, polytetrafluoroethylene, polydimethylsiloxane, polyvinylidene fluoride, polyester fiber, fluorinated ethylene propylene copolymer, polyimide film, and aniline formaldehyde resin film.

There is little or no gap between the high-molecular polymer insulating layer or the modified high-molecular polymer insulating layer and the second high-molecular polymer insulating layer, and there is little or no gap between the second high-molecular polymer insulating layer and the electrode layer.

Micro-nano structures are arranged on at least one of the electrode layer and the second high-molecular polymer insulating layer.

The material used for the high-molecular polymer insulating layer is any one of polydimethylsiloxane, phenolic resin, urea resin, tripolycyanamide resin, unsaturated polyester resin, epikote resin, organic silicon resin, and polyurethane.

A method for preparing a triboelectric pressure sensing cable comprising the following steps:

a. preparing a high-molecular polymer solution: adding a curing agent into a high-molecular polymer to obtain a high-molecular polymer solution, wherein the weight ratio of the curing agent to the high-molecular polymer is 1% to 20%;
b. forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and the lower surface of the sealed cavity structure, respectively;
c. casting: taking down the pipe fitting for sealing through-hole from the hollow cavity framework made in step (2), and pouring the high-molecular polymer solution made in step (1) into the hollow cavity made in step (2), and then sealing the cavity by mounting the pipe fitting for sealing through-hole into the cavity, so as to obtain a casted structure;
d. molding: baking and shaping the casted structure obtained in step (3); and then taking down the pipe fitting for sealing blind-hole, the pipe fitting for sealing through-hole and the auxiliary structure used for forming the cavity; and e. forming an insulating outer layer: winding an insulating outer layer at the outside of the electrode layer after the molding of step (4), so as to obtain the triboelectric pressure sensing cable.

In step (1), the weight ratio of the curing agent to the high-molecular polymer is 10%.

A method for preparing a triboelectric pressure sensing cable comprising the following steps:

a. preparing a modified high-molecular polymer solution: adding a curing agent into a modified high-molecular polymer, which is prepared previously by adding a modified material into a high-molecular polymer, so as to obtain a modified high-molecular polymer solution;
b. forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and lower surface of the sealed cavity structure, respectively;
c. casting: taking down the pipe fitting for sealing through-hole from the hollow cavity framework made in step (2), and pouring the high molecular polymer solution made in step (1) into the hollow cavity made in step (2), and then sealing the cavity by mounting the pipe fitting for sealing through-hole into the cavity, so as to obtain a casted structure;
d. molding: baking and shaping the casted structure obtained in step (3); and then taking down the pipe fitting for sealing blind-hole, the pipe fitting for sealing through-hole, and auxiliary structure used for forming the cavity; and
e. forming an insulating outer layer: winding an insulating outer layer at the outside of the electrode layer after the molding of step (4), so as to obtain the triboelectric pressure sensing cable.

In step (1), the modified material is one or more selected from barium titanate, magnesium titanate, calcium titanate, nano silica, phlogopite, or muscovite.

In step (1), the weight of the modified material is 1% to 45% of that of the modified high-molecular polymer.

If the modified material in step (1) is nano silica, the weight thereof is 1% to 20% of that of the modified high-molecular polymer.

If the modified material in step (1) is barium titanate, the weight thereof is 1% to 45%, and preferably 30%, of that of the modified high-molecular polymer.

In step (1), the weight ratio of the curing agent to the high-molecular polymer is 1% to 20%, and preferably 10%.

The material used for the high-molecular polymer is any one of polydimethylsiloxane (PDMS), phenolic resin, urea resin, tripolycyanamide resin, unsaturated polyester resin, epikote resin, organic silicon resin, and polyurethane.

The central conducting wire is knitted from one or more selected from tin-plated copper conducting wire, zinc-plated copper conducting wire, or silver-plated copper conducting wire.

In step (2), arranging a cladding layer is accomplished by cladding the outside of the pipe fitting for sealing blind-hole and the pipe fitting for sealing through-hole with a strip-form or a band-form electrode layer.

In step (2), the pipe fitting for sealing blind-hole is a blind-hole plug; and the pipe fitting for sealing through-hole is a through-hole plug.

In step (2), the cross-section shape of the pipe fitting for sealing through-hole is the same as that of the pipe fitting for sealing blind-hole.

In step (2), arranging a cladding layer is accomplished by cladding the outside of the pipe fitting for sealing blind-hole and the pipe fitting for sealing through-hole with an auxiliary structure.

After the auxiliary structure is taken down in step (4), the high-molecular polymer insulating layer or the modified high-molecular polymer insulating layer is winded with the electrode layer in the form of a strip, a wire, or a wire-knitted net.

After the auxiliary structure is taken down in step (4), the high-molecular polymer insulating layer is winded with a second high-molecular polymer insulating outer layer.

After the auxiliary structure is taken down in step (4), the second high-molecular polymer insulating layer is winded with the electrode layer in the form of a strip, a wire, or a wire-knitted net.

The material used for the second high-molecular polymer insulating layer is any one of polyvinyl plastics, polypropylene plastics, fluorine plastics, polyvinyl fluoride, fluorinated ethylene propylene, nylon, polyolefin, chlorinated polyethylene, chlorosulfonated polyethylene, silicone rubber, tetrafluoroethylene-ethylene copolymer, polytrifluorochloroethylene, polystyrene, chlorinated polyether, polyimide, polyester, ethylene-vinyl acetate copolymer, thermoplastic vulcanized rubber, thermoplastic polyurethane elastomer rubber, ethylene propylene diene terpolymer rubber, thermoplastic rubber, polyethylene terephthalate, polytetrafluoroethylene, polydimethylsiloxane, polyvinylidene fluoride, polyester fiber, fluorinated ethylene propylene copolymer, polyimide film, and aniline formaldehyde resin film.

After the shaping in step (4), the electrode layer is cladded with a shielding layer, and subsequently winded with the insulating outer layer.

In step (4), the auxiliary structure for forming the cavity is any one of a flexible hollow tube, an acrylic hollow tube, and a water-soluble hollow tube.

In step (3), the casting means is natural injection and/or pressure injection.

The present invention produces advantageous technical effects as follows.

The triboelectric pressure sensing cable provided by the present invention has the following advantages.

The action of external environment upon the triboelectric pressure sensing cable can change the shape of the cable to generate signals, and the goal of monitoring can be achieved by measuring the signals. As proved by experiments, under the same conditions, the signal strength generated by the triboelectric pressure sensing cable of the present invention is greater than that generated by conventional cables, and the monitoring effect which is the same as conventional cables can be achieved without a high input impedance circuit or a charge amplifier, therefore the present invention provides a new method for preparing a triboelectric pressure sensing cable.

The method for preparing a triboelectric pressure sensing cable provided by the present invention has the advantages of easy and convenient operation. The triboelectric pressure sensing cable, comprising a central conducting wire, a doted modified high-molecular polymer insulating layer, an electrode layer, and an insulating outer layer coaxially attached in sequence, has the advantages of compact structure, high stability, long lifetime and marked effects.

### BRIEF DESCRIPTION OF THE DRAWINGS

FIG. 1 shows a specific embodiment of the triboelectric pressure sensing cable according to the present invention;

FIG. 2 shows another specific embodiment of the triboelectric pressure sensing cable according to the present invention;

FIG. 3 shows another specific embodiment of the triboelectric pressure sensing cable according to the present invention;

FIG. 4 shows another specific embodiment of the triboelectric pressure sensing cable according to the present invention;

FIG. 5 is a schematic diagram of a specific embodiment of the preparation method according to the present invention;

FIG. 6 is a schematic diagram of the natural injection of the preparation method according to the present invention;

FIG. 7 shows a specific embodiment of the triboelectric pressure sensing cable according to the present invention;

FIG. 8 shows a specific embodiment of the triboelectric pressure sensing cable according to the present invention;

1—a central conducting wire, 2—a high-molecular polymer insulating layer or a modified high-molecular polymer insulating layer (if the cable is a triboelectric pressure sensing cable, 2 represents the high-molecular polymer insulating layer; if the cable is a modified triboelectric pressure sensing cable, 2 represents the modified high-molecular polymer insulating layer), 3—an electrode layer, 4—an insulating outer layer, 5—a shielding layer, 6—a blind hole plug, 7—a through hole plug, 8—a flexible hollow tube and 9—a second high-molecular polymer insulating layer.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention provides a triboelectric pressure sensing cable comprising a central conducting wire, a high-molecular polymer insulating layer, an electrode layer and an insulating outer layer, which are coaxially attached in sequence; the central conducting wire and the high-molecular polymer insulating layer, and/or the high-molecular polymer insulating layer and the electrode layer generate signals by the means of triboelectric effect, respectively; the central conducting wire and the electrode layer are output electrodes of the triboelectric pressure sensing cable. Materials used for the insulating outer layer can be a variety of soft insulating materials, such as Kapton tape. The central conducting wire and the high-molecular polymer insulating layer are integrated, and there is little or no gap between the high-molecular polymer insulating layer and the electrode layer. The high-molecular polymer insulating layer is molded on the central conducting wire through liquid solidification. The structure of the triboelectric pressure sensing cable is very simple, and signals can be realized by a simple structure consisting of four or five layers without any signal amplification device. Because the triboelectric pressure sensing cable is designed to be integrated, there is no gap among the central conducting wire, the high-molecular polymer layer and the electrode layer, or there is little gap if we consider the situation that it is impossible to stick layers together without any gap among them in the microscopic world.

In one embodiment of the invention, the electrode layer is in the form of a strip, a band, or a wire-knitted net. The material used for the electrode layer is one or more selected from indium tin oxide, silver nanowire membrane, copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, and tantalum alloy. The selected material can be any conductive metal or metal alloy, and preferably copper. The electrode layer in the form of a strip, a band, or a wire-knitted net is used as an output electrode of the triboelectric pressure sensing cable.

The material used for the central conducting wire is one or more selected from copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, tantalum alloy, indium tin oxide, and silver nanowire membrane. The selected material can be any conductive metal or metal alloy, and preferably copper and iron.

In one embodiment of the invention, the material used for the high-molecular polymer is any one of polydimethylsiloxane (PDMS), phenolic resin, urea resin, tripolycyanamide resin, unsaturated polyester resin, epikote resin, organic silicon resin, and polyurethane, and preferably polydimethylsiloxane (PDMS).

In one embodiment of the invention, a shielding layer is arranged between the electrode layer and the insulating outer layer. The shielding layer can be made from the same material as the electrode layer. The electrode layer can further play a role in shielding when the shielding layer isn't arranged. A shielding layer can be further arranged to shield electrical signal so as to achieve a better shielding effect.

In one embodiment of the invention, micro-nano structures are arranged on at least one of the electrode layer and the second high-molecular polymer insulating layer. Micro-nano structures are arranged on the surface of a second high-molecular polymer insulating layer and/or the electrode layer if the triboelectric pressure sensing cable comprises the second high-molecular polymer insulating layer, or micro-nano structures are arranged on the surface of the electrode layer if the triboelectric pressure sensing cable does not comprise a second high-molecular polymer insulating layer.

In one embodiment of the invention, a second high-molecular polymer insulating layer is arranged between the high-molecular polymer insulating layer and the electrode layer.

The present invention also provides a method for preparing the triboelectric pressure sensing cable, which comprises the following steps:

a. preparing a high-molecular polymer solution: adding a curing agent into a high-molecular polymer to obtain a high molecular polymer solution, the weight ratio of the curing agent to the high molecular polymer is 1% to 20%, and preferably, the weight ratio of the curing agent to the high molecular polymer is 10%. In this step, the added curing agent enables the high-molecular polymer to solidify. The type of the curing agent can be determined by a person skilled in the art in accordance with the actual condition.
b. forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and the lower surface of the sealed cavity structure, respectively; the pipe fitting for sealing blind-hole is a blind-hole plug; and the pipe fitting for sealing through-hole is a through-hole plug. The cross-section shape of the pipe fitting for sealing through-hole is the same as that of the pipe fitting for sealing blind-hole, in which the cross-section refers to a section that is perpendicular to the center line of the pipe fitting. The cladding layer is accomplished by cladding the outside of the pipe fitting for sealing blind-hole and the pipe fitting for sealing through-hole with a strip-form or a band-form electrode layer. Alternatively, the cladding layer is accomplished by cladding the outside of the pipe fitting for sealing blind-hole and the pipe fitting for sealing through-hole with an auxiliary structure.

Values of ‘L’ depend on the length of the triboelectric pressure sensing cable, and may be any values greater than zero. During the formation of sealed cavity structure, any methods of forming cavity, not limited to cladding with an electrode layer or an electrode layer, can be applied.

(3) casting: taking down the pipe fitting for sealing through-hole from the hollow cavity framework made in step (2), and pouring the high-molecular polymer solution made in step (1) into the hollow cavity made in step (2), and then sealing the cavity by mounting the pipe fitting for sealing through-hole into the cavity, so as to obtain a casted structure; preferably, the casting means is natural injection and/or pressure injection. After casting, the central conducting wire, the high-molecular polymer insulating layer and the electrode layer are attached in sequence to form a compact and cohesive layer structure, so that cavity cannot form between layers of the layer structure. This kind of structure is beneficial to generate electrical signals by the triboelectric effect between layers. The prepared triboelectric pressure sensing cable has advantages of compact structure, good stability, long life and remarkable effect.

(4) molding: baking and shaping the casted structure obtained in step (3); and then taking down the pipe fitting for sealing blind-hole, the pipe fitting for sealing through-hole and the auxiliary structure used for forming the cavity; the auxiliary structure for forming the cavity is a flexible hollow tube, an acrylic hollow tube or a water-soluble hollow tube. Alternatively, the auxiliary structure for forming the cavity can be any structure used for forming a cavity which is not needed by the triboelectric pressure sensing cable of the invention. During baking and shaping, the temperature and duration time thereof can be determined by a person skilled in the art based on the type of the high-molecular polymer. When the high-molecular polymer is PDMS, the temperature of baking is 70 to 90 and the duration time is 3 to 5 hours.

In one embodiment of the invention, after the auxiliary structure is taken down in step (4), the high-molecular polymer insulating layer is winded with a second high-molecular polymer insulating outer layer, or with the electrode layer in the form of a strip, a wire, or a wire-knitted net, and alternatively, the second high-molecular polymer insulating layer is winded with the electrode layer in the form of a strip, a wire, or a wire-knitted net, so that a complete multilayer structure is formed.

(5) forming an insulating outer layer: winding an insulating outer layer at the outside of the electrode layer after the molding of step (4), so as to obtain the triboelectric pressure sensing cable.

After the molding of step (4), the electrode layer is cladded with a shielding layer and subsequently winded with the insulating outer layer.

In one embodiment of the invention, the structure design of the triboelectric pressure sensing cable is shown in FIG. 1, which is one kind of structure of the triboelectric pressure sensing cable. The central conducting wire is a conducting wire with any diameter which is made from copper, iron and the like, and it plays the role of conductivity and works as one output electrode of the triboelectric pressure sensing cable; the blind-hole plug and the through-hole plug are made from non-conductivity materials and play a supporting role; a copper tape, which works as the other output electrode of the triboelectric pressure sensing cable, and the plugs together form a cylindrical cavity being poured by PDMS; and signals are generated by the triboelectric effect between PDMS and the central conducting wire, and/or the triboelectric effect between PDMS and the electrode layer.

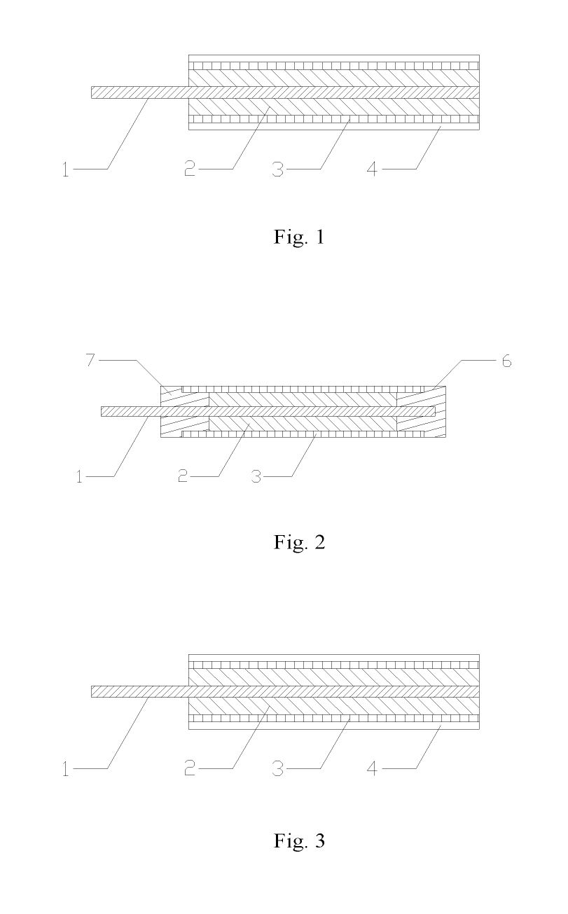

FIG. 2 shows another kind of structure of the triboelectric pressure sensing cable. The central conducting wire is a conducting wire with any diameter which is made from copper, iron and the like, and it plays the role of conductivity and works as one output electrode of the triboelectric pressure sensing cable; the blind-hole plug and the through-hole plug are made from non-conductivity materials and play a supporting role; the flexible hollow tube and the plugs together form a cylindrical cavity being poured by PDMS; the copper tape is the conductivity material used for the other electrode of the triboelectric pressure sensing cable; and signals are generated by the triboelectric effect between PDMS and the central conducting wire, and/or the triboelectric effect between PDMS and the electrode layer.

In one embodiment of the invention, the triboelectric pressure sensing cable is prepared by the method as follows:

Preparation of PDMS. Curing agent is added to the above modified PDMS (the weight ratio of curing agent to high-molecular polymer is 1% to 20%, and preferably 10%) to obtain a mixture via uniform mixing, and then the mixture is put into a vacuum drier to remove the air dissolved in PDMS. A central conducting wire with a certain diameter is selected, the blind-hole plug is mounted at one end of the central conducting wire, the through-hole plug is mounted at a distance of L (the specific value of L can be selected according to the specific requirements), and the cross-section shape of the through-hole plug is the same as that of the blind-hole plug; the two plugs serve as upper and lower surfaces respectively; surface I of the plug is winded with a copper tape which is coated with conducting resin, and the layer number of the tape is more than one; subsequently the through-hole plug is taken down, and the modified PDMS is poured through this port by natural injection or pressure injection (such as injection by a syringe); after the cavity is full, the through-hole plug is mounted again to ensure the central conducting wire does not touch the copper tape, and a casted structure is obtained; and then, the casted structure is put in an oven and the baking temperature and the duration time are 70-90° C. and 3-5 hours, respectively. After baking, the blind-hole plug and the through-hole plug are taken down, and finally the outside of the structure is winded and sealed with Kapton tape.

Further, the present invention provides a triboelectric pressure sensing cable. Preferably, the high-molecular polymer is PDMS doped with a certain amount of barium titanate; the central conducting wire is knitted tin-plated copper wire or knitted silver-plated copper wire, and alternatively, the central conducting wire is knitted from tin-plated copper wire and silver-plated copper wire, which refers to several thin zinc-plated copper wire or tin-plated copper wire knit together to form a knitted zinc-plated copper material or a knitted tin-plated copper material. The triboelectric characteristics of the triboelectric pressure sensing cable is close to capacitive character, so doping with dielectric materials can improve discharge characteristics of the cable effectively. Meanwhile, the interface between doped particles is formed inside the high molecular polymer, which can increase the contact area inside the high-molecular polymer, so as to improve the performance of the triboelectric pressure sensing cable effectively.

Further, the present invention provides a triboelectric pressure sensing cable. The modified high-molecular polymer insulating layer contains a high-molecular polymer and a modified material; and the central conducting wire is knitted from one or more selected from tin-plated copper conducting wire, zinc-plated copper conducting wire, or silver-plated copper conducting wire.

In one embodiment of the invention, the modified material is one or more selected from barium titanate, magnesium titanate, calcium titanate, nano silica, and mica; and the mica is preferable phlogopite or muscovite. The modified material is 1% to 45% of the modified high-molecular polymer in weight. Because the high-molecular polymer is added with modified materials, generating characteristics of the triboelectric pressure sensing cable has been improved by doping modification.

In one embodiment of the invention, the modified high-molecular polymer insulating layer is molded on the central conducting wire through liquid solidification, so that little gap exists between the modified high-molecular polymer insulating layer and the central conducting wire. There is a shielding layer arranged between the electrode layer and the insulating outer layer. The central conducting wire is knitted from one or more selected from tin-plated copper conducting wire, zinc-plated copper conducting wire, or silver-plated copper conducting wire. Further, a second high-molecular polymer insulating layer is arranged between the modified high-molecular polymer insulating layer and the electrode layer. Little or no gap exists between the modified high-molecular polymer insulating layer and the second high-molecular polymer insulating layer, or between the second high-molecular polymer insulating layer and the electrode layer. Micro-nano structures are arranged on at least one layer of the electrode layer and the second high-molecular polymer insulating layer, so that the generated signals can become larger. The material used for the high-molecular polymer insulating layer is any one of polydimethylsiloxane, phenolic resin, urea resin, tripolycyanamide resin, unsaturated polyester resin, epikote resin, organic silicon resin, and polyurethane; preferably, the material is PDMS.

The material used for the electrode layer is one or more selected from indium tin oxide, silver nanowire membrane, copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, and tantalum alloy.

Further, the present invention provides a method for preparing the triboelectric pressure sensing cable, which comprises the following steps.

a. preparing a modified high-molecular polymer solution: adding a curing agent into a modified high-molecular polymer, which is prepared previously by adding a modified material into a high-molecular polymer, so as to obtain a modified high-molecular polymer solution; the modified material is one or more selected from barium titanate, magnesium titanate, calcium titanate, nano silica, and mica. The weight of the modified material is 1% to 45% of that of the modified high-molecular polymer. When the modified material is nano silica, the weight thereof is 1% to 20%, and preferably 15%, of that of the modified high-molecular polymer; when the modified material is barium titanate, the weight thereof is 1% to 45%, and preferably 30%, of that of the modified high-molecular polymer. The weight ratio of the curing agent to the high-molecular polymer is 1% to 20%, and preferably 10%. The material used for the high-molecular polymer insulating layer is any one of polydimethylsiloxane (PDMS), phenolic resin, urea resin, tripolycyanamide resin, unsaturated polyester resin, epikote resin, organic silicon resin, and polyurethane; preferably, the material is PDMS.

In this step, the curing agent enables the modified high-molecular polymer to solidify, and the modified material can increase the signal strength of the triboelectric pressure sensing cable. The type of the curing agent can be determined by a person skilled in the art in accordance with the actual condition.

(2) forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and lower surface of the sealed cavity structure, respectively; the pipe fitting for sealing blind-hole is a blind-hole plug; and the pipe fitting for sealing through-hole is a through-hole plug. The cladding layer is accomplished by cladding the outside of the pipe fitting for sealing blind-hole and the pipe fitting for sealing through-hole with a strip-form or a band-form electrode layer. The pipe fitting for sealing blind-hole is a blind-hole plug, the pipe fitting for sealing through-hole is a through-hole plug, and the cross-section shape of the blind-hole plug is the same as that of the through-hole plug.

Values of ‘L’ depend on the length of the triboelectric pressure sensing cable, and may be any values greater than zero. During the formation of sealed cavity structure, any methods of forming cavity, not limited to cladding with an electrode layer or an electrode layer, can be applied.

(3) casting: taking down the pipe fitting for sealing through-hole from the hollow cavity framework made in step (2), and pouring the high molecular polymer solution made in step (1) into the hollow cavity made in step (2), and then sealing the cavity by mounting the pipe fitting for sealing through-hole into the cavity, so as to obtain a casted structure; the casting means is natural injection and/or pressure injection.

After casting, the central conducting wire, the modified high-molecular polymer insulating layer and the electrode layer are attached in sequence to form a compact and cohesive layer structure, so that cavity cannot form between layers of the layer structure. This kind of structure is beneficial to generate electrical signals by the triboelectric effect between layers. The prepared triboelectric pressure sensing cable has advantages of compact structure, good stability, long life and remarkable effect.

(4) molding: baking and shaping the casted structure obtained in step (3); and then taking down the pipe fitting for sealing blind-hole, the pipe fitting for sealing through-hole, and auxiliary structure used for forming the cavity; and after the auxiliary structure is taken down in step (4), the modified high-molecular polymer insulating layer is winded with the electrode layer in the form of a strip, a wire, or a wire-knitted net. In one embodiment of the invention, after the auxiliary structure is taken down in step (4), the modified high-molecular polymer insulating layer is winded with a second high-molecular polymer insulating outer layer, or with the electrode layer in the form of a strip, a wire, or a wire-knitted net. The material used for the second high-molecular polymer insulating layer is any one of polyvinyl plastics, polypropylene plastics, fluorine plastics, polyvinyl fluoride, fluorinated ethylene propylene, nylon, polyolefin, chlorinated polyethylene, chlorosulfonated polyethylene, silicone rubber, tetrafluoroethylene-ethylene copolymer, polytrifluorochloroethylene, polystyrene, chlorinated polyether, polyimide, polyester, ethylene-vinyl acetate copolymer (EVA), thermoplastic vulcanized rubber (TPV), thermoplastic polyurethane elastomer rubber (TPU), ethylene propylene diene terpolymer rubber (EPDM) or thermoplastic rubber (TPR), polyethylene terephthalate (PET), polytetrafluoroethylene (PTFE), polydimethylsiloxane (PDMS), polyvinylidene fluoride, polyester fiber, fluorinated ethylene propylene copolymer, polyimide film, and aniline formaldehyde resin film. The auxiliary structure used in step (4) to form the cavity is any one of a flexible hollow tube, an acrylic hollow tube, and a water-soluble hollow tube.

Alternatively, the auxiliary structure for forming the cavity can be any structure used for forming a cavity which is not needed by the triboelectric pressure sensing cable of the invention. During baking and shaping, the temperature and duration time thereof can be determined by a person skilled in the art based on the type of the high-molecular polymer. When the high-molecular polymer is PDMS, the temperature of baking is 70 to 90 and the duration time is 3 to 5 hours.

(5) forming an insulating outer layer: winding an insulating outer layer at the outside of the electrode layer after the molding of step (4), so as to obtain the triboelectric pressure sensing cable.

After the molding of step (4), the electrode layer is cladded with a shielding layer and subsequently winded with the insulating outer layer.

In one embodiment of the invention, the central conducting wire, which is made from knitted zinc-plated copper or tin-plated copper, plays the role of conductivity and works as the first output electrode of the triboelectric pressure sensing cable; the electrode layer, which may be a copper strip or a metal wire, works as the second output electrode of the triboelectric pressure sensing cable; signals are generated by the triboelectric effect between the modified high-molecular polymer insulating layer and the central conducting wire, and/or the triboelectric effect between the modified high-molecular polymer insulating layer and the electrode layer.

In one embodiment of the invention, the triboelectric pressure sensing cable is prepared by the method as follows:

A certain proportion (1%-45%) of modified material is added to a high-molecular polymer to obtain a modified high-molecular polymer.

The obtained modified high-molecular polymer is used to prepare the triboelectric pressure sensing cable by the following methods, and preferably by the schemes as follows:

Scheme 1

Curing agent is added to the above modified PDMS (the weight ratio of curing agent to high-molecular polymer is 1% to 20%, and preferably 10%) to obtain a mixture via uniform mixing, and then the mixture is put into a vacuum drier to remove the air dissolved in PDMS. Casting and molding of the prepared modified high-molecular polymer can be performed in several ways. As is shown in FIG. 1, a blind-hole plug, a through-hole plug and a copper tape together form a hollow cavity for casting the modified high-molecular polymer. A central conducting wire with a certain diameter is selected, the blind-hole plug is mounted at one end of the central conducting wire, the through-hole plug is mounted at a distance of L (the specific value of L can be selected according to the specific requirements), and the cross-section shape of the through-hole plug is the same as that of the blind-hole plug; the two plugs serve as upper and lower surfaces respectively; surface I of the plug is winded with a copper tape which is coated with conducting resin, and the layer number of the tape is more than one; subsequently the through-hole plug is taken down, and the modified PDMS is poured through this port by natural injection or pressure injection (such as injection by a syringe); after the cavity is full, the through-hole plug is mounted again to ensure the central conducting wire does not touch the copper tape, and a casted structure is obtained; and then, the casted structure is put in an oven, the baking temperature and the duration time which have been tested are 80° C. and 3-5 hours, respectively. After baking, the outside of the structure is winded with an insulating layer such as Kapton tape. The through-hole plug and the blind-hold plug, which are made from non-conductivity materials, may be taken down after baking.

Scheme 2

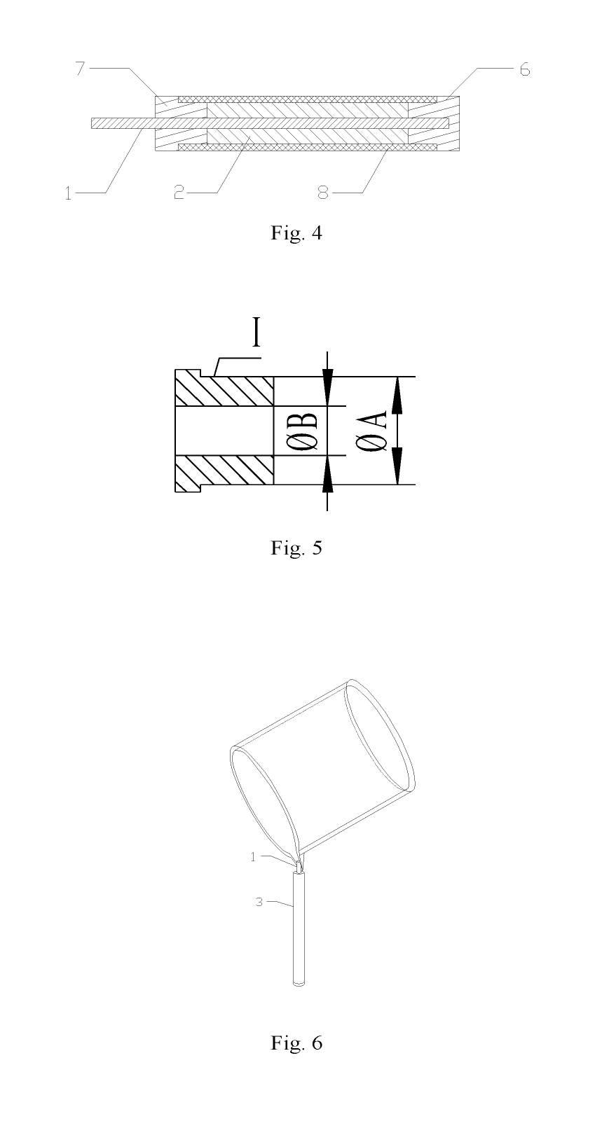

As is shown in FIG. 4, a blind-hole plug, a through-hole plug and a flexible hollow tube together form a hollow cavity for casting the modified high-molecular polymer. The preparation method of the cavity is different from Scheme 1 in that the blind-hole plug, the through-hole plug and the flexible hollow tube together form a hollow cavity for casting the modified high-molecular polymer; after baking, the flexible hollow tube, the blind-hole plug and the through-hole plug are taken down, and the outside of the modified high-molecular polymer layer is winded with metal wires and finally with an insulating layer. The blind-hole plug and the through-hole plug are made from non-conductivity materials.

In one preferable embodiment of the invention, the triboelectric pressure sensing cable is prepared by the method as follows: PDMS is doped with barium titanate, and tin-plated copper conducting wire is used as the central conducting wire; preparation of a modified high-molecular polymer solution: barium titanate is added into PDMS and they are well-mixed, in which the weight ratio of barium titanate to the modified high-molecular polymer is 1% to 45% (preferably 30%), subsequently a curing agent is added and the weight ratio of the curing agent to PDMS is 1% to 20% (preferably 10%), after mix evenly, the process of vacuum exhausting is performed for 30 minutes. The above-mentioned method of casting is used to prepare the triboelectric pressure sensing cable, and after molding, the cable is put in an oven for 4 hours at the temperature of 80° C.

In one embodiment of the invention, silica is added into PDMS and they are well-mixed, in which the weight ratio of silica to the modified high-molecular polymer is 1% to 15% (preferably 8%). The weight range of silica is preferable from 1% to 15%, since excess silica affects the film-forming property of PDMS. Subsequently, a curing agent is added and the weight ratio of the curing agent to PDMS is 1% to 20% (10% in examples), after mix evenly, the process of vacuum exhausting is performed for 30 minutes. The above-mentioned method of casting is used to prepare the triboelectric pressure sensing cable, and after molding, the cable is put in an oven for 4 hours at the temperature of 80° C.

The following examples are merely for the purpose of describing the embodiments of the invention, and the scope of the invention should not be limited by the examples.

### EXAMPLES

The determination methods and material sources of the present invention are described as follows.

Determination method of the voltage: the two electrode output leads of the prepared triboelectric pressure sensing cable are connected to the two input ends of the oscilloscope test equipment, and the electrode of the shielding layer is grounded.

Determination method of the current: the two electrode output leads of the prepared triboelectric pressure sensing cable are connected to the two input ends of the oscilloscope test equipment, and the electrode of the shielding layer is grounded. The determination is carried out under the test condition of 10 N of pressure and 2 Hz of frequency.

High-molecular polymer materials and modified materials used in the examples are all commercially available.

### Example 1

As is shown in FIG. 1, the structure of the prepared triboelectric pressure sensing cable was as follows: a central conducting wire (1), a high-molecular polymer insulating layer (2), an electrode layer (3), and an insulating outer layer (4), which were coaxially arranged from inside to outside.

The preparation method of the triboelectric pressure sensing cable was illustrated with reference to FIG. 2, one end of the cable was the blind-hole plug (6) and the other end of the cable was the through-hole plug (7).

The preparation method comprised the steps of:

500 g of PDMS was added with the curing agent Dow Corning 184 in ratio of 10:1, mixed well, and placed in vacuum drier. Air dissolved in PDMS was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 1# was obtained. The output voltage was determined as 2.5V.

### Example 2

As is shown in FIG. 3, the structure of the prepared triboelectric pressure sensing cable was as follows: a central conducting wire (1), a high-molecular polymer insulating layer (2), an electrode layer (3), and an insulating outer layer (4), which were coaxially arranged from inside to outside. The electrode layer (3) had a network structure.

The preparation method of the triboelectric pressure sensing cable was illustrated with reference to FIG. 4, which is a structural drawing without removal of the blind-hole plug, the through-hole plug and the auxiliary structure for preparing the cavity. One end of the cable was the blind-hole plug (6), the other end of the cable was the through-hole plug (7), and the flexible hollow tube (8) was arranged outside of the high-molecular polymer insulating layer (2). The preparation method comprised the steps of:

500 g of PDMS was added with the curing agent Dow Corning 184 in ratio of 100:1, mixed well, and placed in vacuum drier. Air dissolved in PDMS was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. The flexible hollow tube was put onto the end surface I of the plug, and the layer number of the tape was 2. The through-hole plug was then removed, and the ready-to-use PDMS with air pumped out was injected from this end by pressure injection. The through-hole plug was mounted after full injection, such that the center conducting wire was not in contact with the flexible hollow tube. The center conducting wire was then placed in an oven with the baking temperature of 80° C. for 3 h. The flexible hollow tube, the blind-hole plug and the through-hole plug were removed when baking was completed. A network structure was formed by winding the mental copper wire outside the high-molecular polymer insulating outer layer, and the electrode layer was formed. Lastly, Kapton tape was winded around the outer layer for insulation sealing, and the triboelectric pressure sensing cable 2# was obtained. The output voltage was determined as 2.8V.

### Example 3

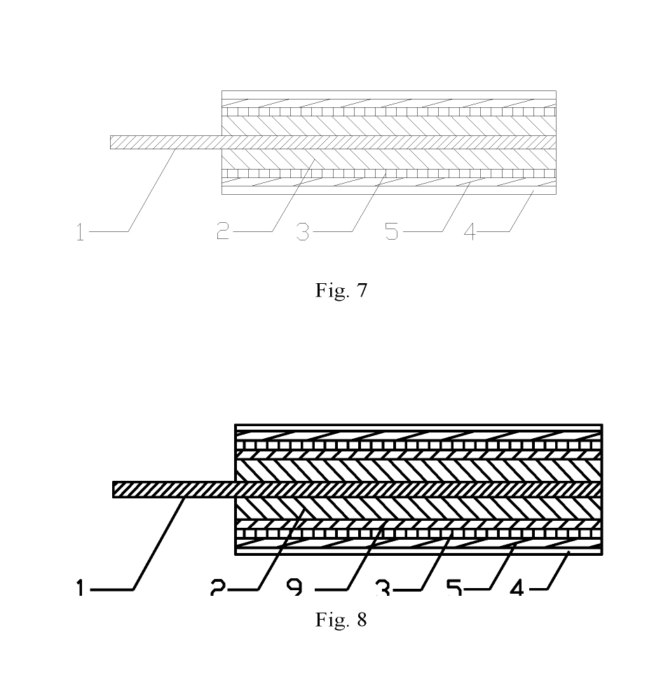

As is shown in FIG. 7, the triboelectric pressure sensing cable comprised a central conducting wire (1), a high-molecular polymer insulating layer (2), an electrode layer (3), a shielding layer (5), and an insulating outer layer (4), which were coaxially arranged from inside to outside.

The preparation method comprised the steps of:

500 g of PDMS was added with the curing agent Dow Corning 184 in ratio of 100:20, mixed well, and placed in vacuum drier. Air dissolved in PDMS was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug to form an electrode layer, and the layer number of the tape was 2. The through-hole plug was then removed, and the ready-to-use PDMS with air pumped out was injected from this end by pressure injection. The through-hole plug was mounted after full injection, such that the center conducting wire was not in contact with copper tape. The center conducting wire was then placed in an oven with the baking temperature of 80° C. for 4 h. The blind hole plug and the through hole plug were removed when baking was completed, 10 tinned copper wires of 0.1 mm were knitted as a shielding layer which winded around the outside of the electrode layer. Lastly, Kapton tape was winded around the outer layer for insulation sealing, and the triboelectric pressure sensing cable 3# was obtained. The output voltage was determined as 3V.

### Example 4

As is shown in FIG. 8, the triboelectric pressure sensing cable comprised a central conducting wire (1), a high-molecular polymer insulating layer (2), a second high-molecular polymer insulating layer (9), an electrode layer (3), a shielding layer (5), and an insulating outer layer (4), which were coaxially arranged from inside to outside.

The preparation method comprised the steps of:

500 g of PDMS was added with the curing agent Dow Corning 184 in ratio of 10:1, mixed well, and placed in vacuum drier. Air dissolved in PDMS was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug to form an electrode layer, and the layer number of the tape was 2. The through-hole plug was then removed, and the ready-to-use PDMS with air pumped out was injected from this end by pressure injection. The through-hole plug was mounted after full injection, such that the center conducting wire was not in contact with copper tape. The center conducting wire was then placed in an oven with the baking temperature of 80° C. for 4 h. The blind hole plug and the through hole plug were removed when baking was completed. The PTEF wire of the second high molecular polymer insulating layer was winded around the outer layer of the copper tape, and 10 tinned copper wires of 0.1 mm were knitted as a shielding layer which winded around the outside of the electrode layer. Lastly, Kapton tape was winded around the outer layer for insulation sealing, and the triboelectric pressure sensing cable 4# was obtained. The output voltage was determined as 2.4V.

### Example 5

As is shown in FIG. 8, the triboelectric pressure sensing cable comprised a central conducting wire (1), a high-molecular polymer insulating layer (2), a second high-molecular polymer insulating layer (9), an electrode layer (3), a shielding layer (5), and an insulating outer layer (4), which were coaxially arranged from inside to outside.

The preparation method comprised the steps of:

500 g of phenolic resin was added with the curing agent petroleum sulfonate in ratio of 10:1, mixed well, and placed in vacuum drier. Air dissolved in petroleum sulfonate was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (the electrode layer), and the layer number of the tape was 2. The through-hole plug was then removed, and the ready-to-use phenolic resin with air pumped out was injected from this end by pressure injection. The through-hole plug was mounted after full injection, such that the center conducting wire was not in contact with copper tape. The center conducting wire was then placed in an oven with the baking temperature of 70° C. for 4 h. The blind hole plug and the through hole plug were removed when baking was completed. The PTEF wire of the second high molecular polymer insulating layer was winded around the outer layer of the copper tape, and 10 tinned copper wires of 0.1 mm were knitted as a shielding layer which winded around the outside of the electrode layer. Lastly, Kapton tape was winded around the outer layer for insulation sealing, and the triboelectric pressure sensing cable 5# was obtained. The output voltage was determined as 2.2V.

### Example 6

Phenolic resin was used for preparing the high-molecular polymer insulating layer, the structure of the triboelectric pressure sensing cable was shown in FIG. 1, and the preparation method thereof comprised the steps of:

500 g of phenolic resin was added with the curing agent petroleum sulfonate in ratio of 10:1, mixed well, and placed in vacuum drier. Air dissolved in petroleum sulfonate was vacuumed.

A copper central conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use phenolic resin with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 1# was obtained. The output voltage was determined as 2.5V.

It could be seen from the data of examples 1 to 6, the output voltages of the triboelectric pressure sensing cables prepared according to the Examples of the present invention, which were up to 2V to 3V, were higher than the traditional pressure cable. The performance was improved significantly.

The modified triboelectric pressure sensing cables were illustrated in below, and the effects thereof were evaluated.

### Example 7

Similar to the triboelectric pressure sensing cable shown in FIG. 1, the structure thereof was as follows: a central conducting wire (1), a modified high-molecular polymer insulating layer (2), an electrode layer (3), and an insulating outer layer (4), which were coaxially arranged from inside to outside.

The preparation method of the triboelectric pressure sensing cable was illustrated with reference to FIG. 2, one end of the cable was the blind-hole plug (6) and the other end of the cable was the through-hole plug (7).

The preparation method comprised the steps of:

500 g of PDMS was added with barium titanate and mixed well. The weight of barium titanate is 1% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes to obtain the modified PDMS.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 1# was obtained. The output voltage was shown in Table 1.

### Example 8

The triboelectric pressure sensing cable similar to that of FIG. 1 could also be prepared by the method comprised the steps of:

500 g of PDMS was added with barium titanate and mixed well. The weight of barium titanate is 30% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 2# was obtained. The output voltage was shown in Table 1.

### Example 9

The triboelectric pressure sensing cable similar to that of FIG. 1 could also be prepared by the method comprised the steps of:

500 g of PDMS was added with barium titanate and mixed well. The weight of barium titanate is 45% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes.

A silver-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 3# was obtained. The output voltage was shown in Table 1.

### Example 10

The triboelectric pressure sensing cable similar to that of FIG. 1 could also be prepared by the method comprised the steps of:

500 g of PDMS was added with nano silica and mixed well. The weight of nano silica is 1% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes.

The central conducting wire was obtained by knitting a tin-plated copper wire of 2.5 mm diameter and a zinc-plated copper wire of 2.5 mm diameter together. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 4# was obtained. The output voltage was shown in Table 1.

### Example 11

The triboelectric pressure sensing cable similar to that of FIG. 1 could also be prepared by the method comprised the steps of:

500 g of PDMS was added with nano silica and mixed well. The weight of nano silica is 8% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 5# was obtained. The output voltage was shown in Table 1.

### Example 12

Similar to the triboelectric pressure sensing cable shown in FIG. 3, the structure thereof was as follows: a central conducting wire (1), a modified high-molecular polymer insulating layer (2), an electrode layer (3), and an insulating outer layer (4), which were coaxially arranged from inside to outside. The electrode layer (3) had a network structure.

The preparation method of the triboelectric pressure sensing cable was illustrated with reference to FIG. 4. One end of the cable was the blind-hole plug (6), the other end of the cable was the through-hole plug (7), and the flexible hollow tube (8) was arranged outside of the high-molecular polymer insulating layer (2). The preparation method comprised the steps of:

500 g of PDMS was added with nano silica and mixed well. The weight of nano silica is 15% of that of the modified high-molecular polymer.

The above well-mixed modified high-molecular polymer was added with the curing agent Dow Corning 184, in which the weight ratio of PDMS to the curing agent is 10:1. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug, the blind-hole plug and the flexible hollow tube were removed when baking was completed. A network structure was formed by winding the mental copper wire outside the modified high-molecular polymer insulating outer layer, and the electrode layer was formed. Lastly, Kapton tape was winded around the outer layer for insulation sealing, and the triboelectric pressure sensing cable 6# was obtained. The output voltage was shown in Table 1.

### Example 13

Similar to the triboelectric pressure sensing cable shown in FIG. 7, the structure thereof was as follows: a central conducting wire (1), a modified high-molecular polymer insulating layer (2), an electrode layer (3), a shielding layer (5), and an insulating outer layer (4), which were coaxially arranged from inside to outside.

The preparation method comprised the steps of:

500 g of PDMS was added with barium titanate and mixed well. The weight of barium titanate is 30% of that of the modified high-molecular polymer.

The above well-mixed modified high-molecular polymer was added with the curing agent Dow Corning 184, in which the weight ratio of PDMS to the curing agent is 100:1. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug and the blind-hole plug were the same. The upper surface and lower surface of the plugs of the two ends were used as end surfaces respectively. Copper tape coated with conducting resin was winded on the end surface I of the plug to form the electrode layer. The through-hole plug was then removed, and the ready-to-use modified PDMS with air pumped out was injected from this end by pressure injection. The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. 10 tinned copper wires of 0.1 mm were knitted as a shielding layer which winded around the outside of the electrode layer. Lastly, Kapton tape was winded around the outer layer for insulation sealing, and the triboelectric pressure sensing cable 7# was obtained. The output voltage was shown in Table 1.

### Example 14

Similar to the triboelectric pressure sensing cable shown in FIG. 8, the structure thereof was as follows: a central conducting wire (1), a modified high-molecular polymer insulating layer (2), an second high-molecular polymer insulating layer (9), an electrode layer (3), a shielding layer (5), and an insulating outer layer (4), which were coaxially arranged from inside to outside.

The preparation method comprised the steps of:

500 g of PDMS was added with barium titanate and mixed well. The weight of barium titanate is 30% of that of the modified high-molecular polymer.

The above well-mixed modified high-molecular polymer was added with the curing agent Dow Corning 184, in which the weight ratio of PDMS to the curing agent is 100:20. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug to form the electrode layer, and the layer number of the tape was 2. The through-hole plug was then removed, and the ready-to-use modified PDMS with air pumped out was injected from this end by pressure injection. The through-hole plug was mounted after full injection, such that the center conducting wire was not in contact with copper tape. The center conducting wire was then placed in an oven with the baking temperature of 80° C. for 4 h. The blind hole plug and the through hole plug were removed when baking was completed. The PTEF wire of the second high molecular polymer insulating layer was winded around the outer layer of the copper tape, and 10 tinned copper wires of 0.1 mm were knitted as a shielding layer which winded around the outside of the copper tape. Lastly, Kapton tape was winded around the outer layer for insulation sealing, and the triboelectric pressure sensing cable 8# was obtained. The output voltage was shown in Table 1.

### Example 15

Phenolic resin was used for preparing the modified high-molecular polymer insulating layer, the structure of the triboelectric pressure sensing cable was similar to that of FIG. 1, and the preparation method thereof comprised the steps of:

500 g of phenolic resin was added with barium titanate and mixed well. The weight of barium titanate is 30% of that of the modified high-molecular polymer.

The above well-mixed modified high-molecular polymer was added with the curing agent petroleum sulfonate, in which the weight ratio of barium titanate to the curing agent is 10:1. The mixture was then well mixed and vacuumed for 30 minutes.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use modified phenolic resin with air pumped out was injected from this end by natural injection (see FIG. 6). The through-hole plug was mounted after full injection, such that the center conducting wire was not in contact with copper tape. The center conducting wire was then placed in an oven with the baking temperature of 70° C. for 5 h. The through-hole plug and the blind-hole plug were removed when baking was completed. Kapton tape was winded around the outer layer for insulation sealing, and the triboelectric pressure sensing cable 9# was obtained. The output voltage was shown in Table 1.

### Example 16

The triboelectric pressure sensing cable similar to that of FIG. 1 could also be prepared by the method comprised the steps of:

500 g of PDMS was added with the curing agent Dow Corning 184 in ratio of 10:1, mixed well, and placed in vacuum drier. Air dissolved in PDMS was vacuumed.

A tin-plated copper conducting wire with a diameter of 5 mm was selected. A blind-hole plug was mounted at one end of the central conducting wire, and a through-hole plug was mounted at a distance of 20 cm. The cross-section shapes of the through-hole plug (6) and the blind-hole plug (7) were the same. The upper surface and lower surface of the plugs of the two ends were used as end surfaces respectively. Copper tape coated with conducting resin was winded on the end surface I of the plug (see FIG. 5), and the layer number of the tape was 2. The through-hole plug was then removed, and the ready-to-use PDMS with air pumped out was injected from this end by natural injection (see FIG. 6). The through-hole plug was mounted after full injection, such that the center conducting wire was not in contact with copper tape. The center conducting wire was then placed in an oven with the baking temperature of 80° C. for 4 h. The through-hole plug and the blind-hole plug were removed when baking was completed. Kapton tape was winded around the outer layer for insulation sealing, and the triboelectric pressure sensing cable 10# was obtained. The output voltage was shown in Table 1.

TABLE 1
Voltage values of the prepared triboelectric pressure
sensing cables according to examples 7 to 16

| | a. Examples | | | | | | | | | |
|---|---|---|---|---|---|---|---|---|---|---|
| Voltage | 7 | 8 | 9 | 10 | 11 | 12 | 13 | 14 | 15 | 16 |
| Output voltage (V) | 3 | 6 | 5.8 | 2.8 | 4.3 | 3.7 | 6.5 | 5 | 5.6 | 2.5 |

It could be seen from the output voltages as determined in examples 7 to 16 (see table 1), doping modified materials into the high-molecular polymer could significantly increase the output signal strength of the triboelectric pressure sensing cable. The voltage values of the obtained triboelectric pressure sensing cables according to examples 8, 9, and 13 to 15 were up to 5V, and particularly, the voltage values of the obtained triboelectric pressure sensing cable according to examples 8 and 15 were up to 6V. No modified material was doped into the high molecular polymer according to example 16, and the electrical signals generated by the triboelectric pressure sensing cable according to example 16 was much less than those of other examples.

Lastly, it shall be noted that the listed were only the specific examples of the present invention, a person skilled in the art could make changes and modifications to the present invention. If the changes and modifications belong to the scope of the claims and their equivalent technology, they shall be considered to fall within the protection scope of the present invention.

1. A triboelectric pressure sensing cable comprising a central conducting wire, a high-molecular polymer insulating layer, an electrode layer and an insulating outer layer, which are coaxially attached in sequence;
the central conducting wire and the high-molecular polymer insulating layer, and/or the high-molecular polymer insulating layer and the electrode layer generate signals by the means of triboelectric effect, respectively; the central conducting wire and the electrode layer are output electrodes of the triboelectric pressure sensing cable.

2. The triboelectric pressure sensing cable of claim 1, wherein the material used for the electrode layer is one or more selected from indium tin oxide, silver nanowire membrane, copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, and tantalum alloy.

3. The triboelectric pressure sensing cable of claim 1 or 2, wherein the material used for the central conducting wire is one or more selected from copper, iron, aluminum, silver, platinum, palladium, aluminum, nickel, titanium, chromium, tin, manganese, molybdenum, tungsten or vanadium, aluminum alloy, titanium alloy, magnesium alloy, beryllium alloy, copper alloy, zinc alloy, manganese alloy, nickel alloy, plumbum alloy, tin alloy, cadmium alloy, bismuth alloy, indium alloy, gallium alloy, tungsten alloy, molybdenum alloy, niobium alloy, tantalum alloy, indium tin oxide, and silver nanowire membrane.

4. The triboelectric pressure sensing cable of any one of claims 1 to 3, wherein the electrode layer is in the form of a strip, a band, or a wire-knitted net.

5. A triboelectric pressure sensing cable comprising a central conducting wire, a modified high-molecular polymer insulating layer, an electrode layer, and an insulating outer layer, which are coaxially attached in sequence;
the central conducting wire and the modified high-molecular polymer insulating layer, and/or the modified high-molecular polymer insulating layer and the electrode layer generate signals by the means of triboelectric effect, respectively; the central conducting wire and the electrode layer are output electrodes of the triboelectric pressure sensing cable, and the modified high-molecular polymer insulating layer contains a high-molecular polymer and a modified material.

6. The triboelectric pressure sensing cable of claim 5, wherein the modified material is one or more selected from barium titanate, magnesium titanate, calcium titanate, nano silica, phlogopite, and muscovite.

7. The triboelectric pressure sensing cable of claim 5 or 6, wherein the weight of the modified material is 1% to 45% of that of the modified high-molecular polymer.

8. The triboelectric pressure sensing cable of any one of claims 5 to 7, wherein the central conducting wire is knitted from one or more selected from tin-plated copper conducting wire, zinc-plated copper conducting wire, or silver-plated copper conducting wire.

9. The triboelectric pressure sensing cable of any one of claims 1 to 8, wherein the high-molecular polymer insulating layer or the modified high-molecular polymer insulating layer is molded on the central conducting wire through liquid solidification.

10. The triboelectric pressure sensing cable of any one of claims 1 to 9, wherein the central conducting wire and the high-molecular polymer insulating layer, or the central conducting wire and the modified high-molecular polymer insulating layer are integrated;
there is little or no gap between the high-molecular polymer insulating layer and the electrode layer, or between the modified high-molecular polymer insulating layer and the electrode layer.

11. The triboelectric pressure sensing cable of any one of claims 1 to 10, wherein a shielding layer is arranged between the electrode layer and the insulating outer layer.

12. The triboelectric pressure sensing cable of any one of claims 1 to 11, wherein a second high-molecular polymer insulating layer is arranged between the high-molecular polymer insulating layer and the electrode layer, or between the modified high-molecular polymer insulating layer and the electrode layer.

13. The triboelectric pressure sensing cable of claim 12, wherein the material used for the second high-molecular polymer insulating layer is any one of polyvinyl plastics, polypropylene plastics, fluorine plastics, polyvinyl fluoride, fluorinated ethylene propylene, nylon, polyolefin, chlorinated polyethylene, chlorosulfonated polyethylene, silicone rubber, tetrafluoroethylene-ethylene copolymer, polytrifluorochloroethylene, polystyrene, chlorinated polyether, polyimide, polyester, ethylene-vinyl acetate copolymer, thermoplastic vulcanized rubber, thermoplastic polyurethane elastomer rubber, ethylene propylene diene monomer or thermoplastic rubber, polyethylene terephthalate, polytetrafluoroethylene, polydimethylsiloxane, polyvinylidene fluoride, polyester fiber, fluorinated ethylene propylene copolymer, polyimide film, and aniline formaldehyde resin film.

14. The triboelectric pressure sensing cable of claim 12 or 13, wherein there is little or no gap between the high-molecular polymer insulating layer and the second high-molecular polymer insulating layer or between the modified high-molecular polymer insulating layer and the second high-molecular polymer insulating layer, and there is little or no gap between the second high-molecular polymer insulating layer and the electrode layer.

15. The triboelectric pressure sensing cable of any one of claims 12 to 14, wherein micro-nano structures are arranged on at least one of the electrode layer and the second high-molecular polymer insulating layer.

16. The triboelectric pressure sensing cable of any one of claims 1 to 15, wherein the material used for the high-molecular polymer insulating layer is any one of polydimethylsiloxane, phenolic resin, urea resin, tripolycyanamide resin, unsaturated polyester resin, epikote resin, organic silicon resin, and polyurethane.

17. A method for preparing a triboelectric pressure sensing cable comprising the steps of:
(1) preparing a high-molecular polymer solution: adding a curing agent into a high molecular polymer to obtain a high molecular polymer solution, the weight ratio of the curing agent to the high molecular polymer is 1% to 20%;
(2) forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and the lower surface of the sealed cavity structure, respectively;
(3) casting: taking down the pipe fitting for sealing through-hole from the hollow cavity framework made in step (2), and pouring the high molecular polymer solution made in step (1) into the hollow cavity made in step (2), and then sealing the cavity by mounting the pipe fitting for sealing through-hole into the cavity, so as to obtain a casted structure;
(4) molding: baking and shaping the casted structure obtained in step (3); and then taking down the pipe fitting for sealing blind-hole, the pipe fitting for sealing through-hole and the auxiliary structure used for forming the cavity; and
(5) forming an insulating outer layer: winding an insulating outer layer at the outside of the electrode layer after the molding of step (4), so as to obtain the triboelectric pressure sensing cable.

18. The method of claim 17, wherein in step (1) the weight ratio of the curing agent to the high-molecular polymer is 10%.

19. A method for preparing a triboelectric pressure sensing cable comprising the steps of:
(1) preparing a modified high-molecular polymer solution: adding a curing agent into a modified high-molecular polymer, which is prepared previously by adding a modified material into a high-molecular polymer, so as to obtain a modified high-molecular polymer solution;
(2) forming a hollow cavity framework used for casting: mounting a pipe fitting for sealing blind-hole at one end of the central conducting wire, mounting a pipe fitting for sealing through-hole at a distance of L from the pipe fitting for sealing blind-hole, and arranging a cladding layer outside of the pipe fitting for sealing blind-hole and the pipe fitting for sealing through-hole, so as to form a sealed cavity structure, with the pipe fitting for sealing blind-hole and the pipe fitting for sealing through-hole being the upper surface and lower surface of the sealed cavity structure, respectively;
(3) casting: taking down the pipe fitting for sealing through-hole from the hollow cavity framework made in step (2), and pouring the high-molecular polymer solution made in step (1) into the hollow cavity made in step (2), and then sealing the cavity by mounting the pipe fitting for sealing through-hole into the cavity, so as to obtain a casted structure;
(4) molding: baking and shaping the casted structure obtained in step (3); and then taking down the pipe fitting for sealing blind-hole, the pipe fitting for sealing through-hole, and auxiliary structure used for forming the cavity; and
(5) forming an insulating outer layer: winding an insulating outer layer at the outside of the electrode layer after the molding of step (4), so as to obtain the triboelectric pressure sensing cable.

20. The method of claim 19, wherein the modified material used in step (1) is one or more selected from barium titanate, magnesium titanate, calcium titanate, nano silica, phlogopite, or muscovite.

21. The method of claim 19 or 20, wherein in step (1) the weight of the modified material is 1% to 45% of that of the modified high-molecular polymer.

22. The method of any one of claims 19 to 21, wherein if the modified material used in step (1) is nano silica, the weight thereof is 1% to 20% of that of the modified high-molecular polymer.

23. The method of any one of claims 19 to 22, wherein if the modified material used in step (1) is barium titanate, the weight thereof is 1% to 45%, and preferably 30%, of that of the modified high molecular-polymer.

24. The method of any one of claims 19 to 23, wherein in step (1) the weight ratio of the curing agent to the high-molecular polymer is 1% to 20%, and preferably 10%.

25. The method of any one of claims 17 to 24, wherein the material used for the high-molecular polymer is any one of polydimethylsiloxane (PDMS), phenolic resin, urea resin, tripolycyanamide resin, unsaturated polyester resin, epikote resin, organic silicon resin, and polyurethane.

26. The method of any one of claims 17 to 25, wherein the central conducting wire is knitted from one or more selected from tin-plated copper conducting wire, zinc-plated copper conducting wire, or silver-plated copper conducting wire.

27. The method of any one of claims 17 to 26, wherein arranging a cladding layer in step (2) is accomplished by cladding the outside of the pipe fitting for sealing blind-hole and the pipe fitting for sealing through-hole with a strip-form or a band-form electrode layer.

28. The method of any one of claims 17 to 27, wherein in step (2) the pipe fitting for sealing blind-hole is a blind-hole plug; and the pipe fitting for sealing through-hole is a through-hole plug.

29. The method of any one of claims 17 to 28, wherein in step (2) the cross-section shape of the pipe fitting for sealing through-hole is the same as that of the pipe fitting for sealing blind-hole.

30. The method of any one of claims 17 to 29, wherein arranging a cladding layer in step (2) is accomplished by cladding the outside of the pipe fitting for sealing blind-hole and the pipe fitting for sealing through-hole with an auxiliary structure.

31. The method of any one of claims 17 to 30, wherein after the auxiliary structure is taken down in step (4), the high-molecular polymer insulating layer or the modified high-molecular polymer insulating layer is winded with the electrode layer in the form of a strip, a wire, or a wire-knitted net.

32. The method of any one of claims 17 to 31, wherein after the auxiliary structure is taken down in step (4), the high-molecular polymer insulating layer or the modified high-molecular polymer insulating layer is winded with a second high-molecular polymer insulating outer layer.

33. The method of any one of claims 17 to 32, wherein after the auxiliary structure is taken down in step (4), the second high-molecular polymer insulating layer is winded with the electrode layer in the form of a strip, a wire, or a wire-knitted net.

34. The method of any one of claims 17 to 33, wherein the material used for the second high-molecular polymer insulating layer is any one of polyvinyl plastics, polypropylene plastics, fluorine plastics, polyvinyl fluoride, fluorinated ethylene propylene, nylon, polyolefin, chlorinated polyethylene, chlorosulfonated polyethylene, silicone rubber, tetrafluoroethylene-ethylene copolymer, polytrifluorochloroethylene, polystyrene, chlorinated polyether, polyimide, polyester, ethylene-vinyl acetate copolymer, thermoplastic vulcanized rubber, thermoplastic polyurethane elastomer rubber, ethylene propylene diene terpolymer rubber, thermoplastic rubber, polyethylene terephthalate, polytetrafluoroethylene, polydimethylsiloxane, polyvinylidene fluoride, polyester fiber, fluorinated ethylene propylene copolymer, polyimide film, and aniline formaldehyde resin film.

35. The method of any one of claims 17 to 34, wherein the electrode layer is cladded with a shielding layer, and subsequently winded with the insulating outer layer.

36. The method of any one of claims 17 to 35, wherein in step (4) the auxiliary structure for forming the cavity is any one of a flexible hollow tube, an acrylic hollow tube, and a water-soluble hollow tube.

37. The method of any one of claims 17 to 36, wherein the casting means applied in step (3) is natural injection and/or pressure injection.
